(19) United States
(12) Patent Application Publication
(10) Pub. No.: US 2002/0077896 A1
(43) Pub. Date: Jun. 20, 2002

(54) Method and apparatus for an electronic billboard system

(76) Inventors: Te-Kai Liu, Mount Kisco, NY (US); Yup-Wu Huang, Chappaqua, NY (US); David Alvra Wood, Scarsdale, NY (US)

Correspondence Address: Duke W. Yee, Carstens, Yee & Cahoon, LLP, P.O. Box 802334, Dallas, TX, 75380, US

(21) Appl. No.: 09/740,204

(22) Filed: Dec. 18, 2000

(51) Int. Cl. G06F 17/60

(52) U.S. Cl. 705/14; 705/10

(57) ABSTRACT

An electronic billboard system includes a display device coupled with a data processing system to display information, such as advertisements, on the display device. The data processing system is further equipped with a wireless communication interface to communicate with mobile devices. Upon seeing a visual presentation of an advertisement on a display device of the present invention, the user may initiate a request from the mobile device to receive information from the data processing system through a wireless communications link with the wireless communications interface. Information is transmitted to the mobile device and presented to the user.

### BACKGROUND OF THE INVENTION

1. Technical Field

The present invention relates generally to an improved data processing system, and in particular to a method and apparatus for presenting information. Still more particularly, the present invention relates to a method and apparatus for transmitting information to a user at a mobile device.

2. Description of Related Art

Advertisement has been one of the major business processes for a long time. For an advertisement campaign to be effective, the information has to be delivered to the right people at the right time and the right place. One type of current advertisement media uses stationary billboards placed at strategic locations to deliver information to potential customers. These mechanical or electronic billboards can display visual information to draw customers'attention, but these billboards are unable to further interact with potential customers who are interested in the information being displayed. If, after viewing the information from a billboard, a potential customer wants to obtain more information or purchase the products/services being advertised, typically the customer copies or writes down the phone number or the web address (i.e., URL) displayed on the billboard. Then, this potential customer establishes a contact with the information source through a separate channel, such as, for example, making a phone call or visiting the web site using a browser. It is possible that a customer interested in the products/services in display either neglected to take down the contact information or did so incorrectly and was not able to find it at a later time. In such a case, the provider of the advertised products/services fails to close a business transaction with this customer.

Wide area wireless Internet services are routinely used for services such as, for example, receiving stock prices, reading e-mail, and checking weather conditions. Due to the expensive air transmission charges and the limited battery life of many wireless devices, wireless users will likely be reluctant to accept advertisements pushed to them at their expense.

Banner advertisements are a popular form of advertisement on the Internet nowadays. These advertisements provide a convenient way (basically one click) for users who are interested in the ads to interact with the advertisement source to get more information and possibly purchase the products and services. Banner advertisements, however, have drawbacks. First, this type of advertisement can only interact with customers who are browsing the web. Furthermore, these advertisements can be very intrusive for web users who do not want to see them because these banner advertisements take up computer window space as well as transmission bandwidth.

Thus, it would be advantageous to have an improved method and apparatus for presenting advertisements and other information to users.

### SUMMARY OF THE INVENTION

The present invention provides an electronic billboard system, which includes a display device coupled with a data processing system to display information, such as advertisements, on the display device. The data processing system is further equipped with a wireless communication interface to communicate with mobile devices. Upon seeing a visual presentation of an advertisement on a display device of the present invention, the user may initiate a request from the mobile device to receive information from the data processing system through a wireless communications link with the wireless communications interface. Information is transmitted to the mobile device and presented to the user.

Further, the information also may include one or more prompts for further actions. For example, a further action may include following through with the advertisement, such as purchasing an item as advertised or obtaining more information, discarding the advertisement, and saving the advertisement.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a network data processing system in which the present invention may be implemented;

FIG. 2 is a block diagram of a data processing system that may be implemented as a server in accordance with a preferred embodiment of the present invention;

FIG. 3 is a block diagram of a PDA shown in accordance with a preferred embodiment of the present invention;

FIG. 4 is a block diagram of a cellular phone in accordance with a preferred embodiment of the present invention;

FIG. 5 is a diagram of a Web portal in accordance with a preferred embodiment of the present invention;

FIG. 6 is a diagram illustrating functional components in an electronic billboard system in accordance with a preferred embodiment of the present invention;

FIGS. 7A and 7B are diagrams illustrating displays on a mobile device in accordance with a preferred embodiment of the present invention;

FIG. 8 is a flowchart of a process for receiving and processing advertisement information in accordance with a preferred embodiment of the present invention;

FIG. 9 is a flowchart of a process used to schedule an advertisement on an electronic billboard system in accordance with a preferred embodiment of the present invention;

FIG. 10 is a flowchart of a process used for displaying advertisements in accordance with a preferred embodiment of the present invention;

FIG. 11 is a flowchart of a process for handling a request for information from a mobile device in accordance with a preferred embodiment of the present invention;

FIG. 12 is a flowchart of a process used for selecting information for transmission to a mobile device is depicted in accordance with a preferred embodiment of the present invention; and

FIG. 13 is a flowchart of a process used for handling a transaction for an item in accordance with a preferred embodiment of the present invention.

### DETAILED DESCRIPTION OF THE PREFERRED EMBODIMENT

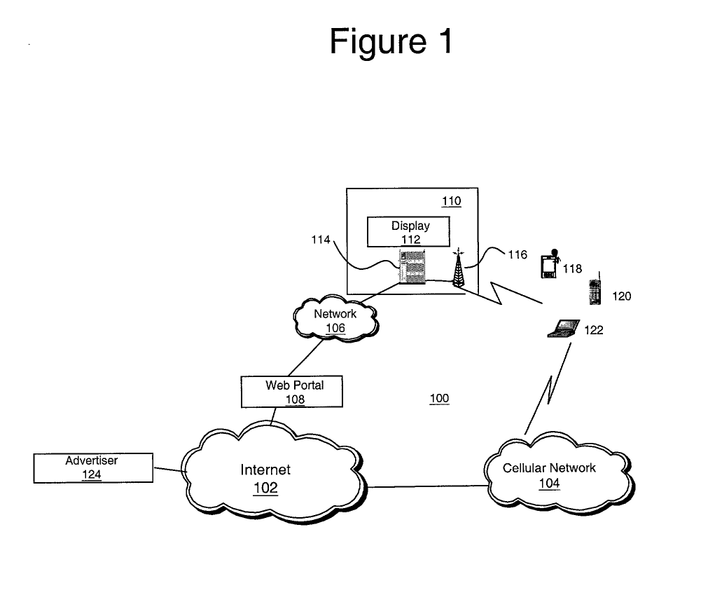

With reference now to the Figures, and particularly with reference to FIG. 1, a diagram of a network data processing system is depicted in which the present invention may be implemented. Network data processing system 100 includes, in this example, Internet 102, cellular network 104, and network 106, which connects web portal 108 and electronic billboard system 110. Cellular network 104 connects mobile devices 118, 120, and 122 to Internet 102, which further interconnects advertiser 124 and web portal 108. Internet 102 represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Network 106 may take various forms, such as a local area network (LAN) or a wide area network (WAN). Cellular network 104 may be implemented using various standards, such as time division multiple access (TDMA) or code division multiple access (CDMA).

In the depicted examples, electronic billboard system 110 is connected to web portal 108 via network 106. Electronic billboard system 110 includes a display 112, a data processing system 114, and a wireless communications unit 116. Wireless communication unit 116 provides an interface to mobile devices, such as mobile devices 118-122. In this example, mobile device 118 is a PDA, mobile device 120 is a cellular phone, and mobile device 122 is a laptop computer with a wireless modem. A mobile device may take various forms, such as, for example, a mobile phone, a personal digital assistant (PDA), and a laptop computer with a wireless modem. These mobile devices are also able to connect to Internet 102 via cellular network 104 in these examples.

Advertisements may be displayed on display 112 in electronic billboard system 110. Display 112 is capable of displaying images and video, as well as presenting audio information. This presentation is controlled by data processing system 114.

These advertisements may be received from various sponsors, such as advertiser 124. Advertisements may be negotiated for and received by Web portal 108, which may possibly hosted by the operator of electronic billboard system 110. Advertiser 124 may connect to Web portal 108 to post advertisements at selected electronic billboard locations. In other words, advertiser 124 may reserve “airtime” at electronic billboard system 110. These advertisements may be distributed to data processing system 114 in electronic billboard 110. Further, this data processing system manages contents to be displayed to be display 112 as well as record usage statistics and providing updates to status of display 110.

Mobile devices 118-122 may request more information regarding an advertisement on display 112 through a wireless connection to electronic billboard system 110 using wireless communication unit 116. Typically, a user or potential customer may view an advertisement displayed on display 112 and request more information on the item or items being presented. These items may be for goods or services. Additionally, other advertisements may be sent to the user in addition to or in place of the information being presented on display 112.

In the depicted examples, the protocol is a short range wireless protocol, such as, for example, Bluetooth wireless technology, or IEEE 802.11 wireless LAN. Bluetooth wireless technology is a specification for small-form factor, low-cost, short range radio links between mobile PCs, mobile phones and other portable devices.

Although only a single electronic billboard system is illustrated in network data processing system 100, additional electronic billboard systems may be located within network data processing system at various locations.

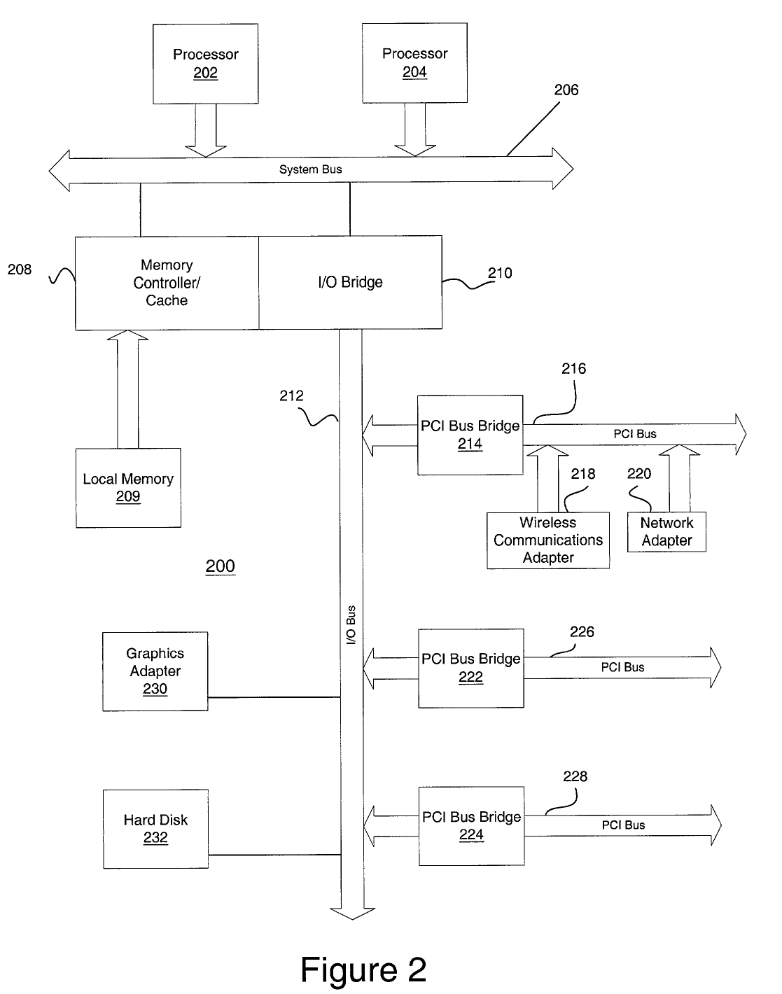

Referring to FIG. 2, a block diagram of a data processing system that may be implemented as a server, such as Web portal 108 or data processing system 114 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network 106 and mobile devices 118-122 in FIG. 1 may be provided through wireless communications adapter 218 and network adapter 220 connected to PCI local bus 216 through add-in boards. Wireless communications adapter 218 provides a connection to wireless communications unit 116 in FIG. 1.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

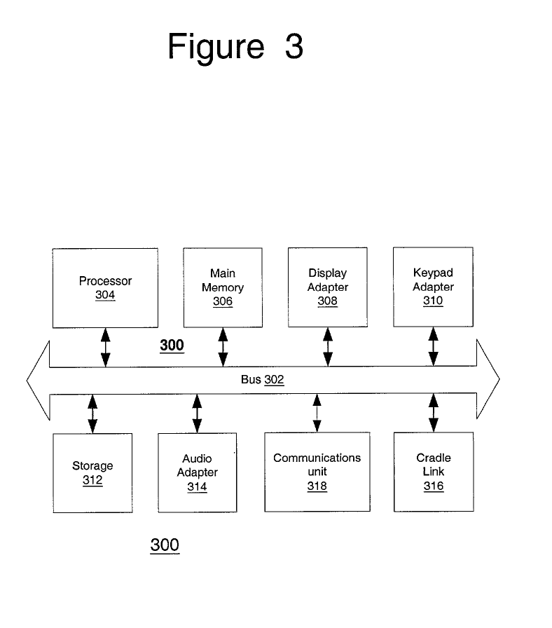

Turning now to FIG. 3, a block diagram of a PDA is shown in accordance with a preferred embodiment of the present invention. PDA 300 is an example of a mobile device, such as mobile device 118 in FIG. 1. Code or instructions implementing the processes of the present invention may be located within PDA 300.

PDA 300 includes a bus 302 to which processor 304 and main memory 306 are connected. Display adapter 308, keypad adapter 310, storage 312, and audio adapter 314 also are connected to bus 302. Cradle link 316 provides a mechanism to connect PDA 300 to a cradle used in synchronizing data in PDA 300 with another data processing system. Communications unit 318 is used to provide data exchange with various sources through a wireless communications link, a phone line, or a network adapter. Further, display adapter 308 also includes a mechanism to receive user input from a stylus when a touch screen display is employed.

An operating system runs on processor 304 and is used to coordinate and provide control of various components within PDA 300 in FIG. 3. The operating system may be, for example, a commercially available operating system such as Palm OS, which is available from Palm Corporation. Instructions for the operating system and applications or programs are located on storage devices, such as storage 312, and may be loaded into main memory 306 for execution by processor 304.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3.

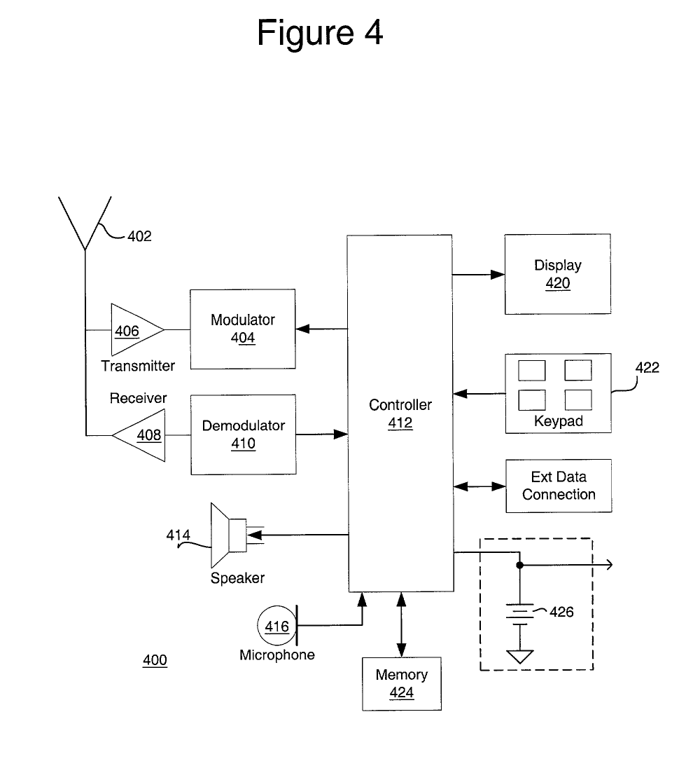

With reference now to FIG. 4, a block diagram of a cellular phone is depicted in accordance with a preferred embodiment of the present invention. Cellular phone 400 is an example of a mobile device, such as mobile device 120 in FIG. 1.

Cellular phone 400 includes an antenna 402 for transmitting signals and receiving signals. Cellular phone 400 also includes a modulator 404, a transmitter 406, a receiver 408, a demodulator 410, and a controller 412. Controller 412 provides signals to and receives signals from transmitter 406 and receiver 408, respectively. These signals include signaling information following the air interface standard of the applicable cellular system and also use speech and/or user generated data. In addition, controller 412 also may include circuitry used for implementing the audio and logic functions of mobile station 400, including the functions for periodic re-registration in response to receiving a paging signal requesting registration of the mobile station. Controller 412 may include a digital signal processor device, a microprocessor device, and various analog to digital converters, digital to analog converters, and other support circuits.

The control and signal processing functions of mobile station 400 are allocated between these devices. Mobile station 400 also includes a speaker 414, a microphone 416, a display 420, and a keypad 422, all of which are coupled to controller 412. In this example, cellular phone 400 also includes a memory 424, which is used to store numbers and various other constants and variables used by controller 412 during operation of cellular phone 400. In addition, cellular phone 400 in this example is powered by a battery 426.

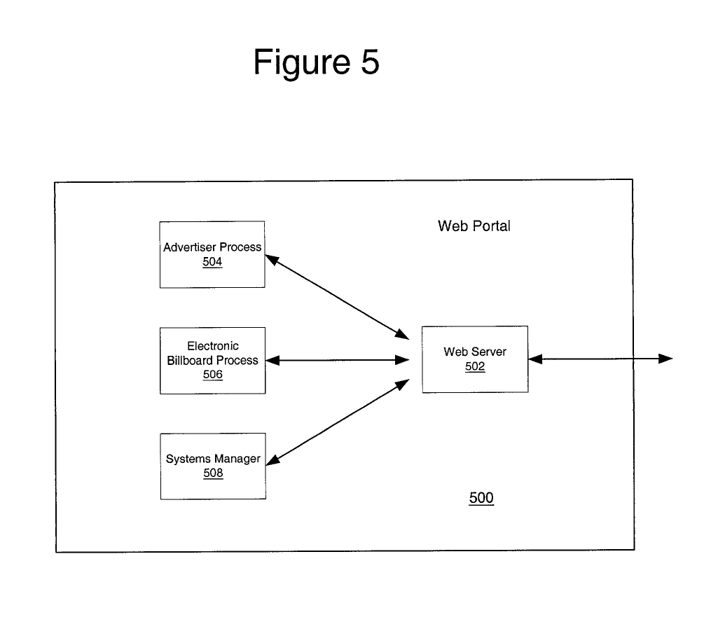

Turning next to FIG. 5, a diagram of a Web portal is depicted in accordance with a preferred embodiment of the present invention. Web portal 500 may be implemented as Web portal 108 in FIG. 1 using a server, such as data processing system 200 in FIG. 2. Web portal 500 provides a mechanism for advertisers to find out the location and capabilities of the currently available electronic billboards. The advertisers can use the services provided by the portal to negotiate the time, location, the advertisement to be aired, the prices, and other terms with the billboard operator. The web portal performs contents management (scheduling, usage tracking, billing, etc.) on a large scale.

When an advertiser submits its ad to Web portal 500, four types of schedules can be requested: “a chunk of time” for premium customers, “round robin” for regular ads, “fill the gap time” for cost conscious customers, and “emergency broadcast” for real time promotion. An advertiser creates its custom made advertisement in the format of a Web page which could includes HTML, Java applets, animated GIF, video, etc. The web page is then uploaded to Web portal 500 of the electronic billboard operator by the advertiser.

In this example, Web portal 500 includes a web server process 502, an advertiser process 504, a billboard process 506, and a systems manager 508. Advertiser process 504 is a Web application, which allows advertisers to submit their advertisement requests. Advertisement process 504 also helps advertisers to negotiate the location, time, and price for showing their advertisements with system manager 508 described below. Electronic billboard process 506 functions to distribute content and the associated schedules to the specified electronic billboard systems, such as electronic billboard system 110 in FIG. 1. This process also communicates with electronic billboard systems for usage tracking and performance monitoring of those systems.

Next, system manager 508 provides a central location to handle resource reservations on a global basis. System manager 508 tracks availability of different electronic billboards for new content or advertisements. In case an advertiser wishes to make an emergency announcement at certain electronic billboard system location, system manager 508 coordinates with the electronic billboard process 506 to notify the corresponding electronic billboard system.

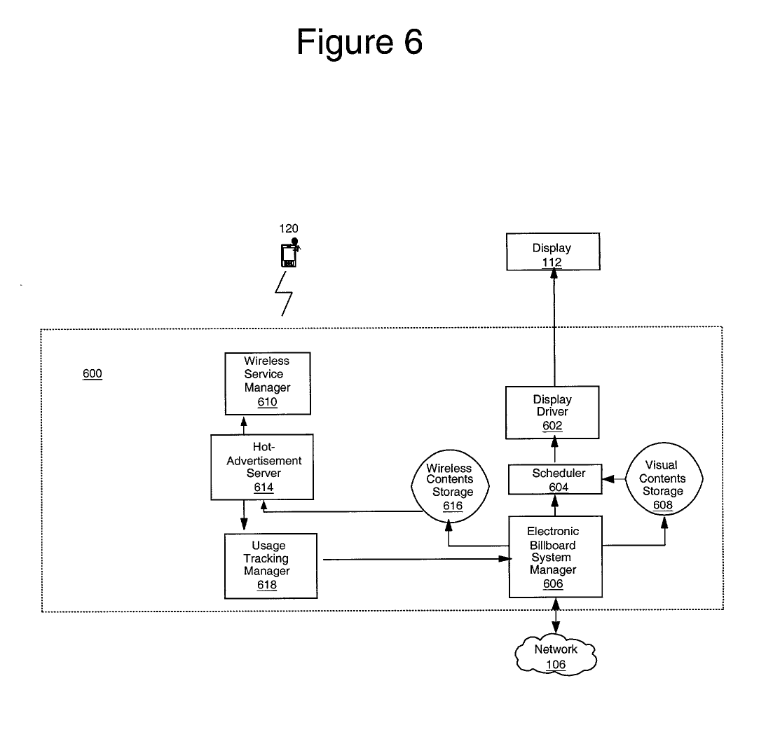

Turning next to FIG. 6, a diagram illustrating functional components in an electronic billboard system is depicted in accordance with a preferred embodiment of the present invention. Data processing system 600 may be implemented using data processing system 200 in FIG. 2, as part of an electronic billboard. Data processing system 600 includes display driver 602, scheduler 604, electronic billboard system manager 606, visual contents storage 608, wireless service manager 610, hot-advertisement server 614, wireless contents storage 616, and usage tracking manager 618.

The display driver 602 renders the contents given to it by scheduler 604. This content is presented on display device 620 for a period of time specified by scheduler 604, which executes the scheduling policy given by the electronic billboard system manager 606. When it is time to render new content, scheduler 604 retrieves the content from visual contents storage 608, and passes the retrieved contents to display driver 602. In addition to visual content storage 608, another type of storage is present for storing information to be downloaded into users'PDAs through the wireless service manager 610 by wireless communication. In this example, this storage is wireless contents storage 616.

Wireless service manager 610 handles the wireless connection with user mobile devices, such as mobile device 120, which is a PDA in FIG. 1. For example, the wireless connection may present a serial interface to devices at both ends of the connection. The Bluetooth serial profile provides such capability. On top of the serial interface of the wireless connection, two devices can communicate using Hyper Text Transport Protocol (HTTP), Wireless Application Protocol (WAP), or other custom design request-and-response protocols. Alternatively, the wireless connection may present a TCP/IP interface to devices at both ends. The Bluetooth LAN access profile provides such capability. Depending on the request-and-response protocol used by the mobile devices, the hot-advertisement server can be implemented by a web server or a WAP server.

Hot-advertisement server 614 keeps track of the few latest advertisements that were rendered on display 620 because these advertisements are more likely to be requested by users. In this profile, when a general request is received, the hot-advertisement server 614 responds with a short list of advertisements, each with a reference number that can go with a specific request sent by users.

Usage tracking manager 618 monitors the activities of hot-advertisement server 614 and updates electronic billboard system manager 606 about the usage statistics of the contents. Electronic billboard system manager 606 is further connected to web portal 108 in FIG. 1 through network 106. Electronic billboard system manager 606 supervises the operation of all electronic billboard systems on the global basis.

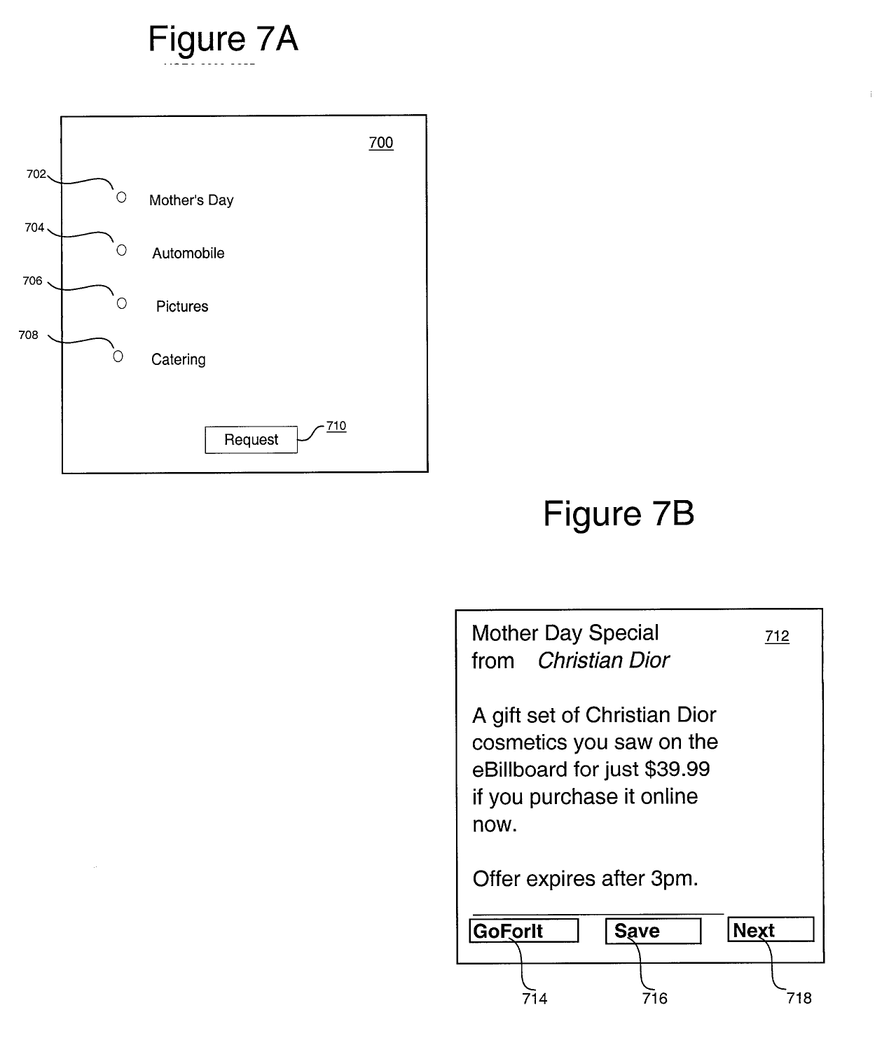

With reference now to FIGS. 7A and 7B, diagrams illustrating displays on a mobile device are depicted in accordance with a preferred embodiment of the present invention. In FIG. 7A, a list of advertisement information is show in screen 700. In this example, the user may select different advertisement information by selecting one or more of entries 702-708 and then depressing request button 710. Typically these entries represent advertisements recently presented on an electronic billboard system, such as electronic billboard system 110 in FIG. 1. Alternatively, these entries may represent advertisements that have been requested most frequently by users. The information illustrated in display 700 is received through a wireless connection with the electronic billboard system.

In this example, display 712 in FIG. 7B is presented in response to a selection of entry 702 in display 700. This information also is received through the wireless connection with the electronic billboard system. In display 712, further actions are presented. The particular actions depend on the particular interface for the mobile device. In this example, the display is an example of one presented on a PDA. Three soft buttons are presented in display 700 for further actions: “Go For It” button 714, “Save” button 716, and “Next” button 718. “Go For It” button 714 is used to initiate a transaction for a particular item being displayed. “Save” button 716 allows a user to save the advertisement information, while “Next” button 718 provides for additional information about the item or information about a different item.

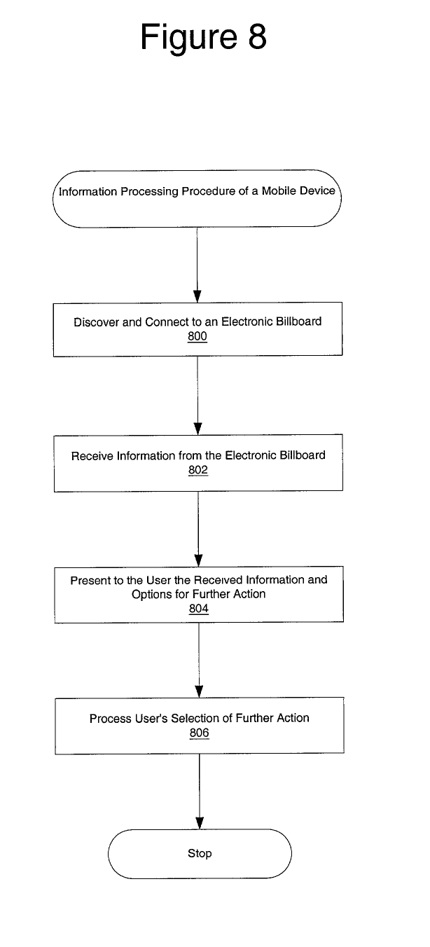

With reference now to FIG. 8, a flowchart of a process for receiving and processing advertisement information is depicted in accordance with a preferred embodiment of the present invention. The process illustrated in FIG. 8 may be implemented in a mobile device, such as mobile device 120 in FIG. 1.

Upon user's activation of the procedure, the mobile device discovers and connects to an electronic billboard system through a wireless connection (step 800). When a wireless connection is made between the mobile device and the electronic billboard system, the mobile device proceeds to receive information from the electronic billboard system, (step 802). The information is then presented to the user and the options for further actions, such as “pursuing further”, “discarding the information”, and “saving the information for later action” (step 804). The selection of a further action is then processed (step 806).

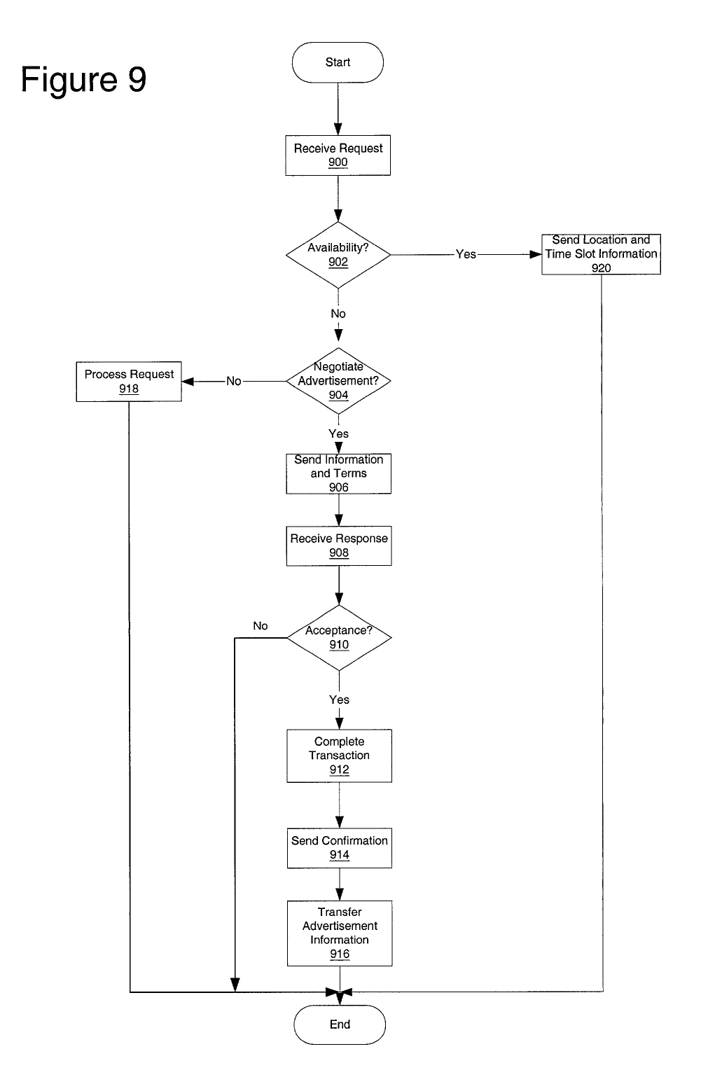

Turning next to FIG. 9, a flowchart of a process used to schedule an advertisement on an electronic billboard system is depicted in accordance with a preferred embodiment of the present invention. This process may be implemented in a computing system, such as Web portal 108 in FIG. 1.

The process begins by receiving a request (step 900). This request is typically received from a business customer who desires to advertise items, such as a goods or services. A determination is made as to whether the request is for an availability to display advertisement information (step 902). If the request is not for availability, a determination is made as to whether the request is to negotiate scheduling of an advertisement (step 904). If the request is for negotiation, then information and terms are sent to the requester, a potential advertiser (step 906). This information in terms may include items, such as dates, locations, and prices for the advertisement. A response is received from the potential advertiser (step 908). The response may include a select of a particular date or dates and location or locations for an advertisement in addition to an acceptance of the terms. A determination is made as to whether the response is an acceptance of the terms (step 910).

If the response contains an acceptance, the transaction is then completed. Completion of the transaction in this example includes completing the financial arrangements for the advertisement. Further, this completion of the transaction also includes receiving the advertisement information from the advertiser. A confirmation is then sent (step 914). Then, the advertisement information is transferred to one or more electronic billboard systems (step 916) with the process terminating thereafter.

With reference again to step 910, if the request is not an acceptance of the terms, the process terminates. Alternatively, instead of terminating, a negotiation process may be initiated to establish terms acceptable to both parties. Turning back to step 904, if the request is not to negotiate an advertisement, the request is processed (step 918) with the process terminating thereafter.

With reference again to step 902, if the request is for availability of electronic billboard systems, location and time slot information for electronic billboard systems are sent to the requester (step 920) with the process terminating thereafter.

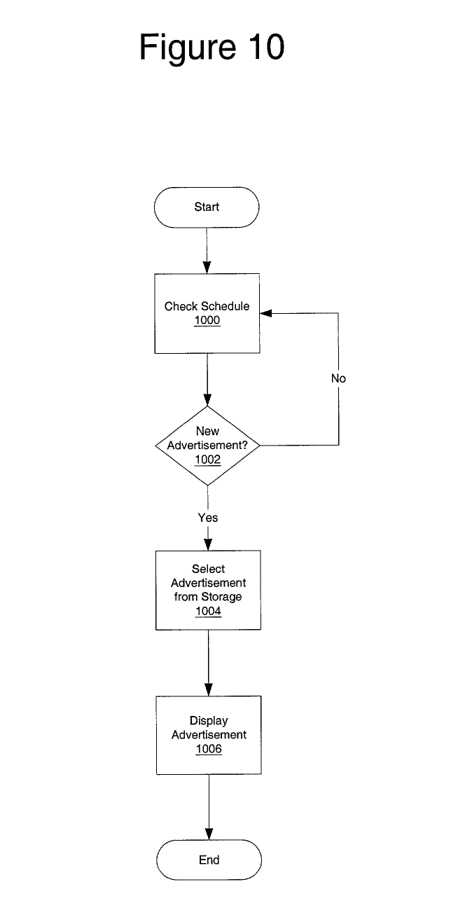

Turning next to FIG. 10, a flowchart of a process used for displaying advertisements is depicted in accordance with a preferred embodiment of the present invention. The process illustrated in FIG. 10 may be implemented in a data processing system, such as data processing system 114 in electronic billboard system 110 in FIG. 1.

The process begins by checking the schedule (step 1000). This schedule contains a list of advertisements that are to be displayed along with the duration and time of display. A determination is made as to whether a new advertisement is to be displayed (step 1002). If new advertisement is to be displayed, an advertisement is selected from storage (step 1004). In this example, the storage is a visual contents storage, such as visual contents storage 608 in FIG. 6. The advertisement is then displayed (step 1006) with the process terminating thereafter. With reference again to step 1002, if a new advertisement is not to be displayed, the process returns to step 1000, as described above.

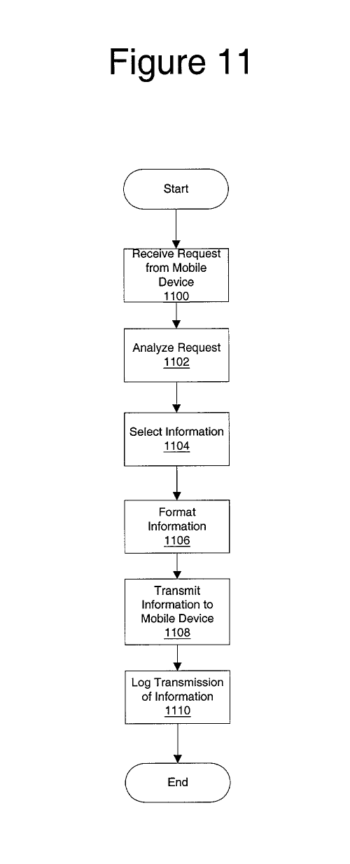

Turning now to FIG. 11, a flowchart of a process for handling a request for information from a mobile device is depicted in accordance with a preferred embodiment of the present invention. The process illustrated in FIG. 11 may be implemented in a data processing system, such as data processing system 114 in electronic billboard system 110 in FIG. 1.

The process begins by receiving a request from a mobile device (step 1100). This request may take various forms, such as, for example, establishment of a wireless connection with the electronic billboard system or a message requesting information for a particular item. The request is analyzed to determine what information to return to the mobile device (step 1102). The analysis may identify a particular list of advertisements or a single advertisement to return to the mobile device. Information is selected based on information in the analysis (step 1104). This information may be selected from a wireless contents storage, such as wireless contents storage 616 in FIG. 6.

Next, the information is formatted for the particular mobile device (step 1106). For example, the information may be into a hypertext markup language (HTML) format, Wireless Markup Language (WML) format, or extensible Markup Language (XML) format. The information is then transmitted to the mobile device (step 1108), and the transmission of the information is logged (step 1110) with the process terminating thereafter. The logging of these transmissions may be used to identify the frequency of requests for information on particular items, as well as maintaining statistical information on mobile devices accessing the electronic billboard system.

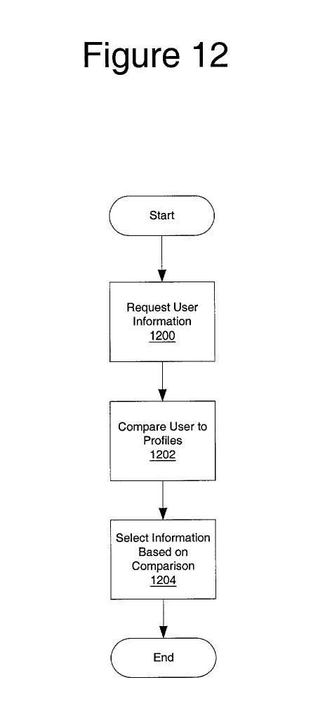

With reference now to FIG. 12, a flowchart of a process used for selecting information for transmission to a mobile device is depicted in accordance with a preferred embodiment of the present invention. The process illustrated in FIG. 12 may be implemented in a data processing system, such as data processing system 114 in electronic billboard system 110 in FIG. 1.

The process begins by requesting user information (step 1200). This information may be requested from the mobile device or from a database of users. The particular user may be identified through a unique identifier in the request for information received from the mobile device in which the unique identifier is associated with user. This information may include, for example, location of the user, occupation, particular buying preferences, and other demographic information.

The information is compared to user profiles (step 1202). The profiles may be associated with the different advertisement information for a particular product in which a particular version of an advertisement is directed towards the particular characteristics of the user described by the profile. The information for transmission to the mobile device is then selected based on the comparison (step 1204) with the process terminating thereafter. For example, if the user profile indicates that the user requesting the information desires detailed information about the item, then a detailed description is provided. If the user profile indicates is cost conscious, then price comparison may be provided in the information.

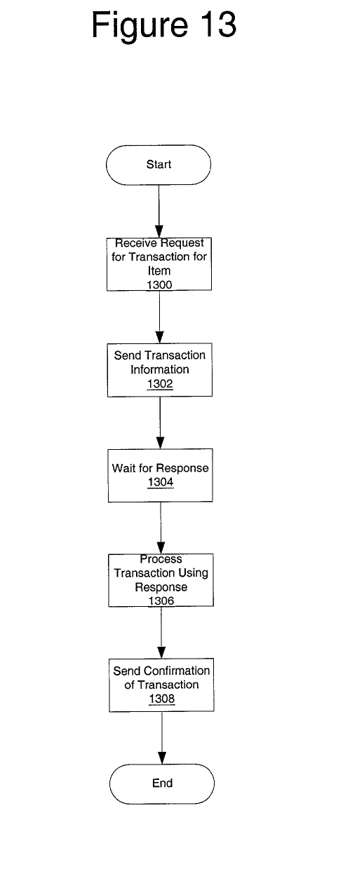

Turning next to FIG. 13, a flowchart of a process used for handling a transaction for an item is depicted in accordance with a preferred embodiment of the present invention. The process illustrated in FIG. 13 may be implemented in a data processing system, such as data processing system 114 in electronic billboard system 110, Web portal 108, or some other data processing system in FIG. 1. This process is used to handle a transaction in response to a user request for the transaction involving an item. The transaction may be, for example, a purchase of the item using a credit card.

The process begins by receiving a request for a transaction involving an item (step 1300). This request may originate from a mobile device in communication with the data processing system in which the request is generated in response to a further user action. For example, a selection of “Go For It” button 714 in FIG. 7B causes the mobile device to generate the request. Transaction information is then sent to the mobile device (step 1302). This transaction information may include, for example, a request for payment information, shipping time, and shipping address. The transaction information also may contain terms for credit purchases, as well as return policies.

The process waits for a response to be returned from the mobile device (step 1304). The transaction is then processed using the response (step 1306). A confirmation of the transaction is then sent to the mobile device (step 1308) with the process terminating thereafter.

Thus, the present invention provides a method, apparatus, and computer implemented instructions for overcoming the above-described problems, disadvantages, and drawbacks of the conventional methods and systems. The mechanism of the present invention provides a method and system for distributing information including advertisements more effectively by taking into account the location and time the information is displayed. Further, The mechanism of the present invention provides a method and system for customers, interested in a specific advertisement displayed on an electronic billboard, to respond to the advertisement in an immediate and easy way. The mechanism of the present invention also allows customers, who are interested in a specific advertisement that had been previously displayed but currently not on the billboard, to respond to the advertisement in an easy way.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for presenting information, the method comprising:
presenting advertisements for at least one item on at least one display device in the data processing system; and
responsive to a request for information about at least one item from a mobile device, transmitting the information about at least one item to the mobile device.

2. The method of claim 1, wherein the item is a product.

3. The method of claim 1, wherein the item is a service.

4. The method of claim 1, wherein the information is transmitted as an extensible markup language document.

5. The method of claim 1, wherein the request includes an establishment of a connection with the data processing system by the mobile device.

6. The method of claim 1, wherein the information includes a list of items and provides for further user action.

7. The method of claim 1, wherein the further user action includes at least one of initiating a transaction for an item, obtaining further information about the item, and obtaining information about another item.

8. The method of claim 1, wherein the presenting step comprises:
presenting each advertisement on the display for a preselected amount of time based on a schedule.

9. The method of claim 1, wherein the data processing system is connected to at least one remote data processing system, further comprising:
receiving new advertisements for presentation from the at least one remote data processing system.

10. The method of claim 7, wherein the data processing system is connected to at least one remote data processing system, further comprising:
forwarding the transaction initiated by the user to the at least one remote data processing system for processing.

11. The method of claim 7, wherein the data processing system is connected to at least one remote data processing system, further comprising:
retrieving the information about the at least one item from one or more remote data processing systems.

12. A method in a data processing system for presenting an advertisement, the data processing system comprising:
displaying initial information about an item on a display device;
receiving a request from a mobile device for additional information about the item, wherein the request is received from a wireless communication link between the data processing system and the mobile device; and
responsive to the request from the mobile device for the additional information about the item, sending the additional information to the mobile device.

13. The method of claim 12, wherein the request comprises an establishment of the wireless communications link between the data processing system and the mobile device.

14. The method of claim 12, wherein the request is a selection of the item from a list of items by a user at the mobile device.

15. The method of claim 12, wherein the additional information is sent in the form of an extensible markup language document.

16. The method of claim 12, wherein the additional information prompts a user at the mobile device to input an action.

17. The method of claim 12, wherein the additional information includes selected information based on a profile associated with the mobile device.

18. The method of claim 17, wherein the profile includes demographic information about a user.

19. The method of claim 12, wherein the additional information includes a selected amount of detail about the item based on a mobile device type.

20. The method of claim 12, wherein the item is at least one of a service and a good.

21. The method of claim 12, wherein the sending step comprises:
requesting approval to send the additional information; and
sending the additional information in response to receiving the approval.

22. The method of claim 12 further comprising:
means for collecting information about the mobile device.

23. The method of claim 12, wherein the sending step comprises multicasting the additional information to each mobile device approving sending of the additional information.

24. The method of claim 12 further comprising:
receiving new information for presentation on the display device form another data processing system.

25. The method of claim 12, wherein the request is a first request and further comprising:
executing a transaction involving the item in response to receiving a second request, wherein the second request is for a transaction.

26. The method of claim 25, wherein the executing step comprises:
sending transaction information to the mobile device in response to receiving the second request;
effecting the transaction in response to receiving a response to the transaction information from the mobile device; and
sending confirmation information to the mobile device after the transaction has been completed.

27. The method of claim 25, wherein the data processing system is connected to at least one remote data processing system and the said transaction is executed by the at least one remote data processing system.

28. A data processing system comprising:
a bus system;
a wireless communications unit connected to the bus, wherein data is sent and received using the wireless communications unit;
a display device connected to the bus system, wherein information is presented on the display device;
a memory connected to the bus system, wherein a set of instructions are located in the memory; and
a processor unit connected to the bus system, wherein the processor unit executes the set of instructions to present advertisements for items on a display device in the data processing system and transmit the information about at least one item to a mobile device in response to a request for information about the item from the mobile device.

29. The data processing system of claim 28, wherein the bus system includes a primary bus and a secondary bus.

30. The data processing system of claim 28, wherein the processor unit includes a single processor.

31. The data processing system of claim 28, wherein the processor unit includes a plurality of processors.

32. The data processing system claim 28, wherein the communications unit is an Ethernet adapter.

33. A data processing system comprising:
a bus system;
a wireless communications unit connected to the bus, wherein data is sent and received using the wireless communications unit;
a display device connected to the bus system, wherein information is presented on the display device;
a memory connected to the bus system, wherein a set of instructions are located in the memory; and
a processor unit connected to the bus system, wherein the processor unit executes the set of instructions to display initial information about an item on a display device; receive a request from a mobile device for additional information about the item, wherein the request is received from a wireless communication link between the data processing system and the mobile device; and send the additional information to the mobile device in response to the request from the mobile device for the additional information about the item.

34. A data processing system for presenting information, the data processing system comprising:
presenting means for presenting advertisements for items on at least one display device in the data processing system; and
transmitting means for transmitting the information about at least one item to a mobile device in response to a request for information about the at least one item from the mobile device.

35. The data processing system of claim 34, wherein the item is a product.

36. The data processing system of claim 34, wherein the item is a service.

37. The data processing system of claim 34, wherein the information is transmitted as an extensible markup language document.

38. The data processing system of claim 34, wherein the request is an establishment of a connection with the data processing system by the mobile device.

39. The data processing system of claim 34, wherein the information a list of items and provides for further user action.

40. The data processing system of claim 34, wherein the further user action includes at least one of initiating a transaction for an item, obtaining further information about the item, and obtaining information about another item.

41. The data processing system of claim 34, wherein the presenting step comprises:
presenting means for presenting each advertisement on the display for a preselected amount of time based on a schedule.

42. The data processing system of claim 34 further comprising:
receiving means for receiving new advertisements for presentation from a remote data processing system.

43. The data processing system of claim 40, wherein the data processing system is connected to at least one remote data processing system, further comprising:
forwarding means for forwarding the transaction initiated by the user to the at least one remote data processing system for processing.

44. The data processing system of claim 40, wherein the data processing system is connected to at least one remote data processing system, further comprising:
retrieving means for retrieving the information about the at least one item from one or more remote data processing systems.

45. A data processing system for presenting an advertisement, the data processing system comprising:
displaying means for displaying initial information about an item on a display device; and
receiving means for receiving a request from a mobile device for additional information about the item, wherein the request is received from a wireless communication link between the data processing system and the mobile device; and
sending means for sending the additional information to the mobile device in response to the request from the mobile device for the additional information about the item.

46. The data processing system of claim 45, wherein the request comprises an establishment of the wireless communications link between the data processing system and the mobile device.

47. The data processing system of claim 45, wherein the request is a selection of the item from a list of items by a user at the mobile device.

48. The data processing system of claim 45, wherein the additional information is sent in the form of a markup language document.

49. The data processing system of claim 45, wherein the additional information prompts a user at the mobile device to input an action.

50. The data processing system of claim 45, wherein the additional information includes selected information based on a profile associated with the mobile device.

51. The data processing system of claim 50, wherein the profiled includes demographic information about a user.

52. The data processing system of claim 45, wherein the additional information includes a selected amount of detail about the item based on a mobile device type.

53. The data processing system of claim 45, wherein the item is at least one of as service and a good.

54. The data processing system of claim 47, wherein the sending means comprises:
requesting means for requesting approval to send the additional information; and
means for sending the additional information in response to receiving the approval.

55. The data processing system of claim 45 further comprising:
collecting means for collecting information about the mobile device.

56. The data processing system of claim 47, wherein the sending means comprises multicasting means for multicasting the additional information to each mobile device approving sending of the additional information.

57. The data processing system of claim 45 further comprising:
receiving means for receiving new information for presentation on the display device form another data processing system.

58. The data processing system of claim 45, wherein the request is a first request and further comprising:
executing means for executing a transaction involving the item in response to receiving a second request, wherein the second request is for a transaction.

59. The data processing system of claim 58, wherein the executing means comprises:
first sending means for sending transaction information to the mobile device in response to receiving the second request;
effecting means for effecting the transaction in response to receiving a response to the transaction information from the mobile device; and
second sending means for sending confirmation information to the mobile device after the transaction has been completed.

60. The data processing system of claim 58, wherein the data processing system is connected to at least one remote data processing system and the transaction is executed by the at least one remote data processing system.

61. A computer program product in a computer readable medium for presenting information in a data processing system, the computer program product comprising:
first instructions for presenting advertisements for items on a display device in the data processing system; and
second instructions, responsive to a request for information about the item from a mobile device, for transmitting the information about at least one item to the mobile device.

62. A computer program product in a computer readable medium for presenting an advertisement in a data processing system, the computer program product comprising:
first instructions for displaying initial information about an item on a display device;
second instructions for receiving a request from a mobile device for additional information about the item, wherein the request is received from a wireless communication link between the data processing system and the mobile device; and
third instructions, responsive to the request from the mobile device for the additional information about the item, for sending the additional information to the mobile device.
